(19) United States
(12) Patent Application Publication
(10) Pub. No.: US 2022/0215017 A1
(43) Pub. Date: Jul. 7, 2022

(54) SYSTEMS AND METHODS FOR INFORMATIVE GRAPHICAL SEARCH

(71) Applicant: RELX Inc., Miamisburg, OH (US)

(72) Inventor: Mahesh Pendyala, Folsom, CA (US)

(73) Assignee: RELX Inc., Miamisburg, OH (US)

(21) Appl. No.: 17/142,687

(22) Filed: Jan. 6, 2021

(51) Int. Cl. G06F 16/248; G06Q 50/18; G06F 16/901

(52) U.S. Cl. CPC G06F 16/248; G06F 16/9024; G06Q 50/18

(57) ABSTRACT

Systems and methods generate hierarchical displays of search results from a document corpus or documents. The hierarchical displays include parent nodes and children nodes. The parent nodes identify broader concepts and children nodes identify narrower concepts. Concepts can be terms of art, areas of law, or the like. Hierarchical displays may be modified to add or remove nodes. Analysis tools may provide metrics for assessing a document corpus, search query, or search results.

### TECHNICAL FIELD

The present disclosure relates to systems and methods for generating search results of legal documents and, more particularly, to systems and methods for generating search results based on terms of art and graphically displaying search results.

### BACKGROUND

Documents within a corpus are often linked together by citations. For example, legal documents and scientific articles often cite to previous works to support a particular rule, proposition or finding. In the legal corpus context, an author of a judicial opinion often cites previous cases in support of his or her own legal statement or rule. In turn, these cited cases have themselves also cited and/or been cited by other cases in support of the proposition-in-question (and so on). Therefore, selected documents within the corpus are intrinsically linked together around particular issues, and these links can be manifested in the form of citation networks.

Researchers often search the corpus for documents that discuss a particular issue or legal term of art. They may search through documents to find use of a term of art. However, documents, such as legal documents, may discuss many different topics or legal issues. Further, the same legal term of art may be related to different legal concepts, statutes, or the like. Currently, the researcher does not know the particular legal concept to which a search result relates until the user examines the document. The researcher must therefore sift through the many different documents. Moreover, because of a lack of understanding of how particular issues are connected or otherwise related, the researcher may not perform a thorough and complete investigation into the original issue or research topic.

Accordingly, a need exists for alternative methods of generating search results from documents within a corpus of documents. Further, there is a need for improved systems and methods for displaying search results.

### SUMMARY OF INVENTION

Disclosed is a computer-implemented method of generating search results from a document corpus. The method may provide for using a computer, document corpus wherein the document corpus comprises a plurality of documents arranged according to a structured legal taxonomy hierarchy, wherein the structured legal taxonomy hierarchy is associated with legal concepts for the plurality of documents; identifying a set of documents from the document corpus in response to receiving a search query. The method may include instructing an interface to display a hierarchical graph comprising a plurality of nodes associated with the set of documents, wherein each node includes a label identifying a legal concept associated with the node, and wherein children nodes comprise narrower legal concepts than their parent nodes. In an aspect, the method may include instructing the interface to display branch metadata under at least one label for at least one node. The branch metadata may include legal terms of art associated with metadata for documents associated with the at least one node. The method may include propagating common branch metadata of sibling nodes to a parent node. In another example, the method may include generating a weight for each of the plurality of nodes according to associated legal concepts. The method may include instructing the interface to render a visual indicator of the eights of each of the plurality of nodes. In another aspect, the method may include receiving preferences associated with a user and instructing the interface to display the hierarchical graph based at least in part on the preferences. Further, the method may include modifying the hierarchical graph according to user input. The method may include modifying the graph comprises at least one of pruning, deleting, saving, or combining some or all of the hierarchical graph. It is noted that the method may further comprise calculating a metric associated with the hierarchical graph based on at least one of the number of first level nodes, total number of nodes, number of edges, number of paths, tree height, or number of legal concepts. In some examples, the method may further include comparing the metric to a threshold to determine whether to provide a suggestion for modifying the search query.

Also described is a computer-implemented system for generating search results from a document corpus, the computer-implemented system comprising a processor and a non-transitory computer-readable medium storing computer readable instructions that, when executed by the processor, cause the processor to: search the document corpus for a set of documents based on a search query, wherein the document corpus includes a plurality of documents arranged in a structured taxonomy hierarchy, wherein the taxonomy is associated with concepts; generate a hierarchical interface comprising nodes identified by concepts, wherein documents of the set off documents are linked to the nodes based on the concepts, and wherein children nodes comprise narrower concepts than their parent nodes; and instruct an interface device to display the hierarchical interface, wherein input selecting a candidate node of the hierarchical interface directs the interface device to display documents associated with the candidate node. In examples, the system may further include computer readable instructions that cause the processor to instruct the interface device to display a graphical representation of the hierarchical interface. In another example, the concepts comprise at least one of legal concepts, scientific concepts, or research concepts. According to some examples, the computer readable instructions may cause the processor to filter the documents associated with the candidate node based on at least one filter criteria. It is further noted that at least one filter criteria comprises a practice area, date, or jurisdiction.

Additionally described is a computer-implemented method of generating a hierarchical summary of a document, the method comprising: providing, using a computer, a structured taxonomy hierarchy associated with a document corpus, wherein the structured taxonomy hierarchy is associated with a plurality of concepts; identifying concepts within the document based on the structured taxonomy hierarchy; generating a hierarchical structure representing the hierarchical summary of the document, wherein nodes of the hierarchical structure are associated with concepts such that parent nodes comprise concepts that encompass concepts of children nodes; and instructing an interface to display the hierarchical structure. The method may include performing a search of a document corpus for documents associated with the nodes of the hierarchical structure. In some examples, the concepts comprise at least one of a fact pattern, a term of art, or a legal concept. According to an aspect, the method may include storing the hierarchical structure in a memory.

These and additional features provided by the embodiments described herein will be more fully understood in view of the following detailed description, in conjunction with the drawings.

### BRIEF DESCRIPTION OF DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a computing network for a system for generating hierarchical search results, according to embodiments shown and described herein;

FIG. 2 depicts a schematic illustration of the server computing device from FIG. 1, further illustrating hardware and software that may be utilized in performing the generation of hierarchical search results, according to embodiments shown and described herein;

FIG. 3 depicts an interface rendering of search results according to one or more embodiments shown and described herein;

FIG. 4 depicts another interface rendering of search results according to one or more embodiments shown and described herein;

FIG. 5 depicts an interface rendering of a document summary according to one or more embodiments shown and described herein according to one or more embodiments shown and described herein; and

FIG. 6 depicts a flow diagram of a method for generating hierarchical search results according to one or more embodiments shown and described herein.

### DETAILED DESCRIPTION

Embodiments described herein are directed to systems and methods for generating search results from a corpus and providing the search results in a graphical representation. Nodes on the graph represent different areas of law or legal terms of art. Children nodes identify sub topics or areas of law which are more specific than a parent node. A rendering of the graphical representation may identify a node's area of law (e.g., torts, governments, real property law, intellectual property law, etc.). In at least some embodiments, branch metadata may be rendered along with a node's area of law. The branch metadata information may include legal terms of art, short descriptions of issues, key words, concepts, fact patterns, or the like that are common to all children of a particular node. The branch metadata is generally narrower than an area of law

As used herein, an area of law may include a legal concept, issue, subject, statute, or the like. Such areas of law may have sub-areas defining more narrow concepts, issues, subjects, or the like. In an example, an area of law may be “criminal law.” A sub-area of “criminal law” may be “assault,” “liability,” “defenses,” or the like. Such areas or sub-areas may be identified by legal terms of art (e.g., words or phrases that have a particular meaning in an area of law). Further, areas of law may be identified or described by terms of art.

In an aspect, rendering search results in the form of a graph may allow a user (e.g., legal researcher, attorney, judge, etc.) to quickly identify research paths more pertinent to their research needs. For instance, a search query may be processed and may generate search candidates (e.g., hits) in a range of different areas of law. The areas of law may be related to each other or may be unrelated. Providing a rendering of results organized into areas of law with legal terms of art may allow a user to view results in a way that matches their cognitive thought process. In another aspect, the user may be able to identify areas of law to expand research or adapt a legal strategy based on relation to a search query.

According to at least some embodiments, described systems and methods may provide analysis tools that may refine search results, generate suggestions to alter search results, or the like. In some instances, graphical representations of search results may be pruned to eliminate one or more nodes. Pruned nodes may be removed from search results, saved as a separate search result, or the like. Pruning nodes may allow a user to remove candidates or otherwise narrow search results.

It is noted that examples may include analysis tools that provide analytical metrics pertaining to search results in response to a search query. The analytical metrics may include tree complexity measurements to identify spread, saturation, or the like. In examples, a trees complexity may signify that search results were spread among a wide variety of legal topics. This may indicate that the search query was overly broad. Disclosed systems and methods may identify suggestions, modifications, or the like to a user such that a user may refine a search query. In some examples, the systems and methods may automatically refine search results and may identify refinements to a user.

It is noted that embodiments of the present disclosure may include or interact with a corpus of documents that may include metadata identifying legal concepts, key words, or other information that summarizes or tags legal concepts of a particular document. For instance, systems and methods may extract legal terms of art (e.g., legal issues, fact patterns, etc.) from a case law corpus (or other corpus) and store those issues in a library (e.g., a legal issue library, area of law library, etc.). The building of the library may rely on a data-mining process that collects legal terms of art in the corpus based on semantics-based network traversing, human interaction, or the like. In some examples, issues that are found are then normalized and may be stored in a library. Embodiments may additionally or alternatively uncover relationships between individual issues themselves, and form a hierarchical classification of issues.

For instance, embodiments may combine a structured legal taxonomy hierarchy with weighted legal concepts and fact phrases. The combination of the structured legal taxonomy hierarchy with linear lists of legal concepts or fact patterns may be filtered based on a user's query or input. Common concepts, fact patterns in the sibling nodes may be propagated to parent node, keeping only specific, applicable items at the child nodes, precisely reflecting the legal terms of art relevant at any node. Legal concepts may be weighted and ordered for users to know the importance of a concept, allowing them to pay attention to salient legal concepts. As described here and elsewhere in this disclosure, search result graphs can be personalized for a user's practice area, jurisdiction, search session, or the like.

Although the embodiments are described herein in the context of a corpus of legal documents, it should be understood that embodiments are not limited thereto. For example, the systems and methods described herein may be utilized to generate renderings for search results for scientific research documents, news articles, journals, online data (e.g., Wikipedia articles) and any other type of large corpus of documents where documents are linked by citations, classified by hierarchical topics, or the like.

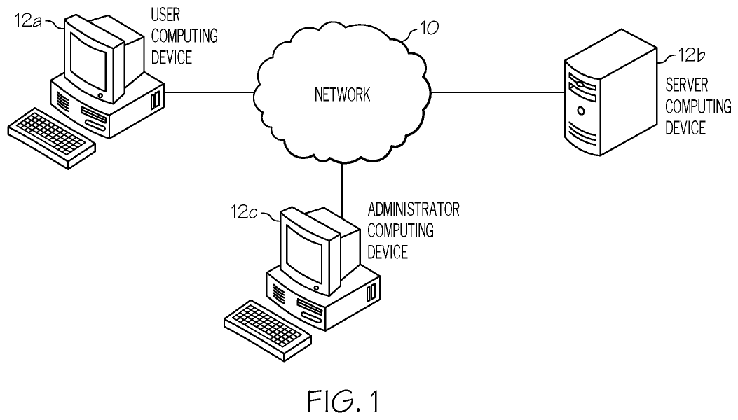

Referring now to the drawings, FIG. 1 depicts an exemplary computing network, illustrating components for a system for generating search results from documents within a corpus, according to embodiments shown and described herein. As illustrated in FIG. 1, a computer network 10 may include a wide area network, such as the internet, a local area network (LAN), a mobile communications network, a public service telephone network (PSTN) and/or other network and may be configured to electronically connect a user computing device 12a, a server computing device 12b, and an administrator computing device 12c. For instance, embodiments may utilize various radio access network (RAN), e.g., wireless fidelity (Wi-Fi), global system for mobile communications, universal mobile telecommunications systems, worldwide interoperability for microwave access, enhanced general packet radio service, xth generation partnership project long term evolution (e.g., 3G LTE, 4G LTE, 5G LTE, etc.), third generation partnership project 2, BLUETOOTH®, ultra-mobile broadband, high speed packet access, xth generation long term evolution, or another IEEE 802.XX technology. Furthermore, embodiments may utilize wired communications.

The user computing device 12a may be used to generate queries for searching an electronic document corpus as well as display search results in a hierarchical interface as described here and elsewhere in this disclosure. The user computing device 12c may also be utilized to perform other user functions. Additionally, included in FIG. 1 is the administrator computing device 12c. In the event that the server computing device 12b requires oversight, updating, or correction, the administrator computing device 12c may be configured to provide the desired oversight, updating, and/or correction.

It should be understood that while the user computing device 12a and the administrator computing device 12c are depicted as personal computers and the server computing device 12b is depicted as a server, these are non-limiting examples. More specifically, in some embodiments any type of computing device (e.g., mobile computing device, personal computer, server, smart phone, tablet computer, wearable device, set top box, etc.) may be utilized for any of these components. Such computing devices may include various other devices that may comprise hardware and/or software (e.g., program threads, processes, computer processors, non-transitory memory devices, etc.). It is noted that such computing device may perform some or all functions described herein. Additionally, while each of these computing devices is illustrated in FIG. 1 as a single piece of hardware, this is also an example. More specifically, each of the user computing device 12a, server computing device 12b, and administrator computing device 12c may represent a plurality of computers, servers, databases, or other devices communicatively coupled together.

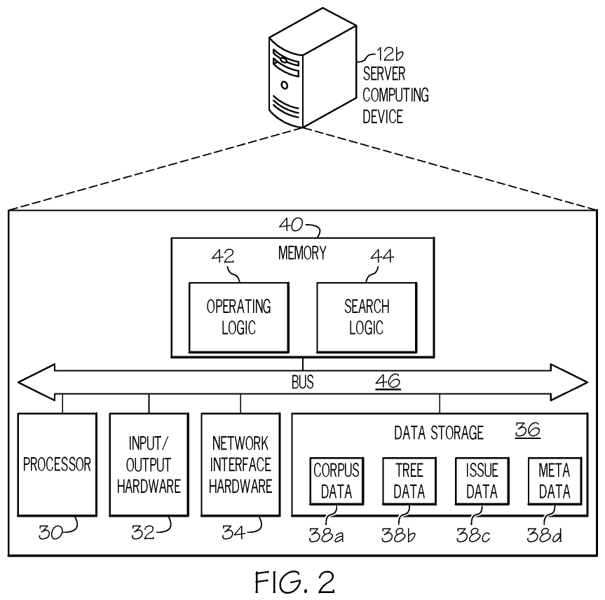

FIG. 2 depicts the server computing device 12b, from FIG. 1, further illustrating a system comprising a non-transitory computer-readable medium for receiving search queries, performing searches, generating search results, and instructing display of search results generating issue libraries and networks embodied as hardware, software, and/or firmware, according to embodiments shown and described herein. It is noted that the server computing device 12b may be include hardware, software, and/or firmware. In at least some embodiments, that server computing device 12b may be configured as a special purpose computer designed specifically for performing the functionality described herein.

As also illustrated in FIG. 2, the server computing device 12b may include a processor 30, input/output hardware 32, network interface hardware 34, a data storage component 36 (which stores corpus data 38a, tree data 38b, issue data 38c, and metadata 38d), and a memory component 40. The memory component 40 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store operating logic 42 and search logic 44 (each of which may be embodied as a computer program (i.e., computer readable instructions), firmware, or hardware, as an example). A bus 46 is also included in FIG. 2 and may be implemented as an interface to facilitate communication among the components of the server computing device 12b.

The processor 30 may include any processing component configured to receive and execute computer readable instructions (such as from the data storage component 36 and/or memory component 40). The input/output hardware 32 may include a monitor, keyboard, mouse, printer, camera, microphone, speaker, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data for access by the server computing device 12b and/or other components. As illustrated in FIG. 2, the data storage component 36 stores corpus data 38a, which in at least one embodiment, includes legal and/or other documents that have been organized and indexed for searching. The legal documents may include case decisions, briefs, forms, treatises, etc. Other documents may also be stored, such as scientific documents.

In an example, the corpus data 38a may include a corpus of documents containing individual documents. Each document may include metadata, such as identification of areas of law, identification of legal terms of art, a citation that references a particular passage or text, or the like. The corpus data 38a may be a legal corpus comprising many individual judicial opinions. In some common-law countries, such as the United States, the legal system is based on stare decisis, wherein judges are obligated to follow the precedents established by prior judicial decisions. When preparing a judicial or legal opinion, the judge or person preparing the opinion must cite to documents to support particular rules, statements and facts. Likewise, parties which argue for a particular legal position (e.g., plaintiffs, defendants, etc.) or opinion also cite to documents to support arguments, statements, and facts. Citations typically make reference to a document for a specific area of law, key term of art, or the like. Legal research is often performed by searching prior and subsequent cases of a legal issue based on citations located within each document. Researchers typically review broad areas of law and attempt to focus research to identify documents most pertinent to the specific facts and issues of a case. Therefore, providing a user with search results organized into hierarchical areas of law may be beneficial for efficient legal research.

According to at least some embodiments, the corpus data 38a may include documents comprising metadata that identifies legal concepts (e.g., legal issues, concepts, terms of art, etc.) tagged or otherwise linked to some or all of the document. For example, a given document may comprise a judicial opinion discussing a range of different legal topics (e.g., jurisdiction, admissibility of evidence, liability, etc.). Metadata may be linked to a particular passage(s), an overall document, or the like. It is further noted that documents within the corpus data 38a may include metrics on the degree of depth or relevance for a particular legal concept. The metric may include a scaled metric (e.g., percentage, scaled token, etc.), number of relevant passages, or other metric. The metric may be measured based on user (e.g., human) input, computer algorithms, a combination of user input and computer algorithms, or the like.

It is noted that although instances of a legal concept may be phrased differently, they may have the same semantic meaning (e.g., legal term of art). For example, there may be many ways to describe a particular rule of law; however, each description of the particular rule of law, although different, may be semantically the same. In an aspect, the legal concepts of such may be normalized to a particular legal term of art. Normalization of the many issues discussed within the document corpus allows the issues to be searched and organized into a network. Moreover, the corpus data 38a may identify related areas of law that may be identified as related based on user input, data-mining, and semantics-based traversing or the like.

At least some examples, may include corpus data 38a that may be arranged in networks with interconnected nodes based on occurrences of legal concepts. Determination of which nodes are parent nodes and which nodes are children nodes may be based on normalized legal concepts, which may rank issues occurring more often or having generally large amounts of applicability as parent nodes. As issues become less common or narrow, they may be identified as children nodes. It is noted that the corpus data 38a may arranged in an existing corpus that may continuously add documents to nodes or create new nodes as documents are added to a corpus. For example, in a legal corpus, judicial opinion documents that are issued by a court may be analyzed as described herein and then respective passages may be added to the proper node. Embodiments described herein also take normalized issues extracted from a document corpus and extract one or more issue networks based on the interconnectedness of the normalized issues within the corpus.

In some embodiments, tree data 38b generated by the search logic 44a may be stored by the data storage 36 and may include information relating to the semantically identified documents or portions of documents. Issues data 38c may also be stored by the data storage 36 and may include legal issues that may be tagged via metadata 38d to data related to text excerpts or tagged portions of a document.

Included in the memory component 40 are the operating logic 42 and the search logic 44. The operating logic 42 may include an operating system and/or other software for managing components of the server computing device 12b. In another aspect, the search logic 44 may reside in the memory component 40 and may be configured to facilitate searching of corpus data 38a, such as in response to a search query. The search logic 44 may be configured to compile and/or organize search results based on hierarchical metadata to enable user applications, such as electronic document search and retrieval, organization of the documents within the corpus, and generation of one or more networks of issues.

It should be understood that the components illustrated in FIG. 2 are merely exemplary and are not intended to limit the scope of this disclosure. More specifically, while the components in FIG. 2 are illustrated as residing within the server computing device 12b, this is a non-limiting example. In some embodiments, one or more of the components may reside external to the server computing device 12b. Similarly, while FIG. 2 is directed to the server computing device 12b, other components such as the user computing device 12a and the administrator computing device 12b may include similar hardware, software, and/or firmware.

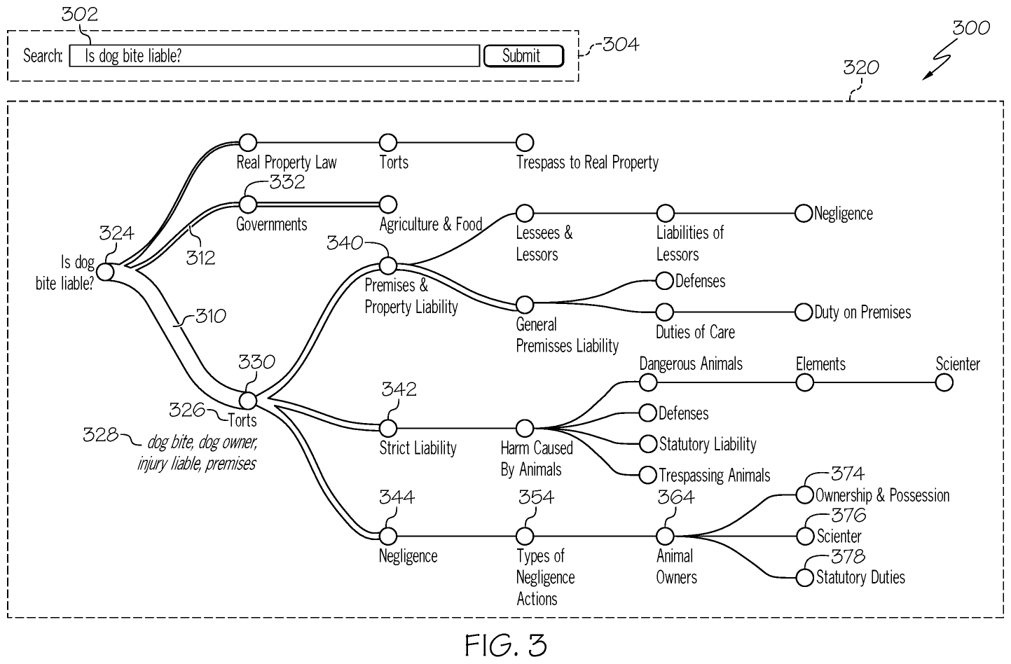

Turning to FIG. 3, there is an exemplary interface 300 of an end user application. The interface 300 may be rendered, for example, by a user computing device 12a in response to information provided by the server computing device 12b. In embodiments, a user may provide a search query 302 to search query input 304. The search query 302 may contain a structured search, natural language search, or the like. While the illustrated example relates to a legal query of “Is dog bite liable?,” it is noted that a query may relate to any legal issue or other issue relevant to a particular corpus of documents.

In embodiments, a user may enter the search query 302 into the search query input 304. The user may submit the query, which may be executed by a local or remote computing device (e.g., server computing device 12b). In examples, terms in the search query 302 may be run to identify “hits” or matched words within a corpus of documents and/or within metadata or legal concepts. It is noted that searching algorithms may utilize key word matching, data mining, or other appropriate techniques for identifying a document. In some examples, searching techniques may utilize artificial intelligence, statistical models, or other processes and/or algorithms. For instance, classifiers may be mapped to an attribute vector to a confidence that the attribute belongs to a class. An input attribute vector, x=(x1, x2, x3, x4, xn) may be mapped to f(x)=confidence(class). Such classification can employ a probabilistic and/or statistical based analysis (e.g., factoring into the analysis user selected filters, user settings, search histories, or the like) to infer an action that a user desires to be performed, documents a user is searching for, legal concepts related to a search query, or the like. In various embodiments, systems and methods may utilize other directed and undirected model classification approaches include, e.g., naïve Bayes, Bayesian networks, decision trees, neural networks, fuzzy logic models, and probabilistic classification models providing different patterns of independence. Classification may also include statistical regression that is utilized to develop models of priority.

Once search results are identified, the results may be displayed via the interface 300. In some embodiments, the results may be displayed in traditional lists where documents are presented one at a time. A user may filter results, sort results, or otherwise interact with the results. In addition or alternatively, the user may select to view the results in a graphical display or the interface may automatically render the results in a graphical display, such as in hierarchical interface 320.

As described here and elsewhere, the hierarchical interface 320 may include a graph comprising nodes that represent different areas of law, such as nodes 330 and 332 which may depend from a query node 324, which may be identified as a level 0 node. Nodes depending from the query node 324 (e.g., level 1 nodes) generally relate to distinct areas of law where there is little if any cross over. For instance, node 332 relates to governmental issues and node 330 relates to tort law. Children nodes depending from the level 1 nodes (e.g., nodes 330, 332, etc.) relate to sub topics or areas of law which are more specific than a parent node. As an example, nodes 340, 342, and 344 may relate to more narrow legal concepts that fall with in the broader legal concept represented at node 330. As illustrated, node 330 includes a label 326 that may comprise a character string or other token identifying the area of law of the node, in this case “Torts.” It is noted that each node after level 1 may include a label identifying the area of law. Node 340 may relate to a sub area of torts, such as “premises and property liability.” Similarly, node 342 relates to another sub area of torts “strict liability.” Node 344 relates to another sub area, “negligence.” Moreover, node 344 may include further sub areas or children nodes, such as node 354 related to “types of negligence actions,” which in turn, has a child node 364 related to “animal owner.” Moreover, node 364 may have children nodes 374, 376, 378, respectively related to “ownership &possession,” “scienter,” and “statutory duties.” It is noted that the size of the tree (e.g., number of nodes, number of edges, and depth) may be variable depending on the search query, user settings, administer settings, or the like. In some examples, parameters of a tree may be present to restrict the size of the tree, whereby areas of law having the least relevance or least number of hits may be hidden or removed from the tree. It is further noted, however, that the size of a graph generally does not increase or decrease much based on the number of search results. This may be because certain legal concepts may include a large number documents which may be represented as one particular node. Moreover, some documents may be associated with multiple nodes.

It is further noted that one or more nodes may include branch metadata 328. The branch metadata 328 may be provided as a character string, such as one or more legal term of art. For instance, note 330 may include the legal terms of art “dog bite,” “dog owner,” “injury liable,” and “premises.” In an aspect, this may allow a user to quickly identify and visualize key topics in search results. The branch metadata 328 may be identified for each node and child node. In at least some examples, common concepts in sibling nodes (e.g., nodes of the same level having the same parent) are propagated to their parent node, keeping only specific, applicable concepts at the child nodes. It is further noted that search results may be constrained by a user's configuration parameters. Such parameters may include practice area, jurisdiction, subscription level or access to particular documents, or the like.

In at least some embodiments, graphical hierarchies or trees may be prebuilt and saved in memory. Search queries may be associated with one or more graphs, which may be combined and pruned according to the search query or user input. This may reduce time needed to search for each document in a corpus as nodes may be prepopulated with documents.

The user may provide input to select one or more of the nodes via the hierarchical interface 320. Once selected, the user may be directed to a list of results. For example, selection of node 344 may cause the interface 300 to render a list of search results that are associated with node 344 and each child node of node 344, such as nodes 354, 364, 374, 376, and 378. It is noted that documents from the corpus that relate to node 344 and its children may be presented via an ordered list, via a popup window, or the like.

After or during review of the results or selection of documents, a user may return to the hierarchical interface 320 and explore other nodes, prune nodes, save some or all of the nodes to a user account, or the like. For example, the user may review results related to node 344 and may identify the results as particularly relevant. The user may desire to save the branch for further research. Described systems and methods may allow the user to save the branch to a user account.

In another aspect, the hierarchical interface 320 may identify one or more nodes or branches as comprising a larger amount of search results. For instance, visual indicator 310 comprises a branch having a thickness that is greater than visual indicator 312. The thickness may indicate a relatively greater number of documents related to node 330 than node 332. It is noted that other visual indicators may provide, such as colors, highlights, differently shaped paths, focused graphics, differently sized nodes, graphical images, alphanumerical indicators, or the like. Moreover, the hierarchical interface 320 may provide visual indicators of weighted legal concepts that identify other or different information, such as relative citations by other documents within a corpus, likelihood of relevancy, most recent information, new documents, or the like.

According to at least some embodiments, systems and methods may provide analysis tools. The analysis tools may reside in search logic 44, user applications, or the like. The analysis tools may allow a user to revise, filter, or otherwise modify the hierarchical interface 320. Modification of the hierarchical interface 320 may alter results or documents in the search results.

For instance, analysis tools may allow a user to prune, hide, or otherwise alter a node displayed in the hierarchical interface 320. As an example, the user may view node 332 and legal terms of art associated with node 332 and/or terms of art associated with its children. The user may then determine that node 332 is irrelevant and may provide input, via an analysis tool, to remove (e.g., prune, hide, etc.) the node 332 from hierarchical interface 320. The removed node may be eliminated from the rendering of the hierarchical interface 320. In some embodiments, the user may elect to save the removed node, open the node in a new window or tab, or remove the node completely. The node may then be removed from display.

In some embodiments, the hierarchical interface 320 may be adjusted through moving remaining nodes, enlarging remaining nodes, providing additional details, or the like. It is noted that embodiments may track removal of nodes to allow a user to undue actions, provide feedback to systems and methods such that future search results may be improved, or the like. As an example, embodiments may track a history associated with nodes. A history of removal of the node may indicate that the node is being included in search results where the node may not be particularly relevant. This may allow embodiments to remove the node in future searches containing similar search queries or otherwise alter search algorithms, metadata, or the like.

Additionally or alternatively, a user may provide input to manipulate the hierarchical interface 320. For instance, the user may move or re-order nodes or branches, search within a branch or node, expand nodes, append additional nodes, and combine search queries or search results relating to different queries or the like. As an example, a user may enter one or more queries and embodiments may provide a hierarchical interface 320 of search results for each query. Automatically or based on input from the user, the hierarchical interface 320 may include a graph for each query. The graphs may be overlaid onto each other, separated, color coded, or the like. In other examples, the graphs may be merged by linking like nodes from each search. As such, a user may enter multiple queries to search for documents within corpus data 38a. The intersection of different nodes in search results may indicate that certain nodes contain information that may be of high relevance.

In another example, the analysis tool may provide analytical metrics pertaining to search results in response to a search query. The analytical metrics may include tree complexity measurements to identify spread, saturation, or the like. In examples, a trees complexity may signify that search results were spread among a wide variety of legal topics. This may indicate that the search query was overly broad.

The analysis tool may utilize tree theory to identify metrics or characteristics of search results. For instance, the analysis tool may determine whether a user needs help creating a more targeted query, or the like. The metrics or characteristics may include the number of first level nodes, the total number of nodes, the number of edges, the number of paths, tree height or depth, number of legal concepts, number of fact phrases, or the like. As example, if a total number of nodes or number of first nodes are too large, the search results are likely too broad, which may mean that the user's query is too broad. This may indicate whether or not the user is close to an answer it is seeking. As described herein, metrics may be based on one or more characteristics of a tree.

An exemplary embodiment may utilize a metric defined as “O( )” where 00=N₁²+N+E+the number of unique concepts), where N₁ equals the number of first level nodes, “N” equals the number of nodes, and “E” is the number of edges. Intuitively, too many first level nodes indicates too many distinct areas of law or practice areas of law. Further, too many or too few nodes, paths, and edges indicate the search is either too broad or narrow, or too complex or simple. In examples, too many first level nodes, paths, or total nodes in the graph may correspond to too many practice areas or sub-areas-of-law are involved. This may imply that a user's search may be too wide or generic (incomplete). As such, the search may need to be refined. Likewise, too few first level nodes, paths, or total nodes implies a narrow, restricted search. In some embodiments, customer support may contact a user or suggestions may be provided.

The time complexity for a user to grok, read, or otherwise understand the information presented in the hierarchical interface 320 in a breadth first search or depth first search can be measured as “T( ),” where T( )=N+E. That is, the time a user would need to look at each in the hierarchical interface 320 is proportional to the number of nodes and the number of edges. The analytical measurements may allow for a measure of usefulness of the hierarchical interface 320 based on the search query and search results.

It is noted that other tree theory metrics may be utilized as metrics for the search query or search results. For example, empirical value ranges may be used to measure the complexity, such as in the style of cyclomatic complexity measurements. In another aspect, the diameter of the graph may be utilized as a metric. The diameter may comprise the maximum distance between all node pairs. The diameter of the hierarchical interface 320 may comprise an additional or alternative measure for how long it would take a user to visually scan the graph. It is noted that other metrics associated with hierarchal graphs or trees may be utilized to determine usefulness, helpfulness, or quality of search results.

It is noted that the tree theory metrics described herein may be utilized with other metrics to determine relevance or likely relevance of documents (e.g., usefulness, etc.). For instance, some embodiments may utilize historic data associated with a node, document, term of art, or the like to sort, rank, or otherwise classify the utilization of particular search results. Historical data may include a number of times a document or node is clicked, length of time on a node or document, number of times a node or document is selected for view, saves of a node or document, or the like.

Embodiments may identify when a user may need to modify a search query or may need assistance in research according to a metric. For example, if the hierarchical interface 320 includes a large number of first level nodes, the user's search may be overly broad. Systems and methods may alert the user to the breadth of the search and may provide suggestions to the user. A suggestion may be a textual message indicating the search may need to be narrowed, identification of nodes or branches to be culled, identification of terms of art to include in a search, or the like. Suggestions may be based on user input (e.g., an administrative user providing suggestions), statistical models, artificial intelligence, learning algorithms, or the like. It is noted that suggestions may be provided to a user via a notification or may be made automatically, without requiring user action.

Described embodiments may additionally or alternatively allow an administrator or search provided to analytical tools to measure the significance of certain legal concepts. In an example, a certain issue tag or term of art may result in very few documents from the corpus data 38a or may have a history indicated that the issue tag is rarely in search results or rarely selected for further review. This may allow the administrator to determine that certain issue tags may be of little use and may be removed from corpus data 38a. In other examples, systems and methods may identify issue tags which tend to be associate with overly broad searches. An administrator may narrow or expand the issue tag to more discrete issues. For instance, hierarchical graphs may be generated and combined for an entire corpus. The combined graph may allow an administrator to view an entire taxonomy and/or corpus summary.

The distribution of legal concepts measures the diversity, evenness of taxonomy. For instance, Shannon's Diversity: H=−ΣPi*ln(Pi); may be applied to determine the evenness of a corpus taxonomy, where Pi is proportion of unique concepts for a topic (#per topic/total). In another example, Pielou's Evenness: J=H/ln(S); may be applied where H is Shannon's diversity and S is the total number of topics, J ranges from 0 (no evenness) to 1 (completely even). Analytical tools may be provided to summarize the evenness or diversity according to these or other measures.

Moreover, a graph for the entire corpus may only need to be generated once. When additional nodes or legal concepts are identified the graph may be expanded by appending nodes rather than generating a new graph.

While a hierarchical tree is generally discussed above, it is noted that other hierarchical structures or graphical descriptions of results may be utilized. For instance, embodiments may utilize pie charts, Venn diagrams, dot charts, or the like. As an example, search results may be depicted as one or more pie charts. A pie chart may be correspond to each level 1 node. Children nodes of the level 1 node may be depicted as slices of the pie chart. In another example, Venn diagrams may be provided where each node is represented by a circle or other shape.

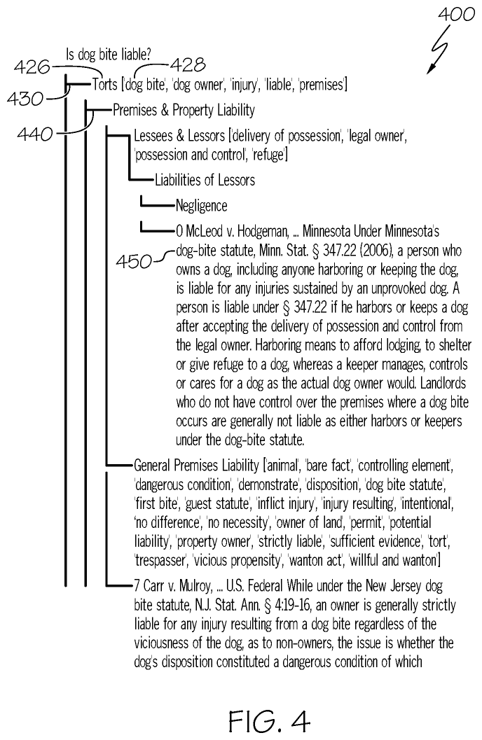

FIG. 4 illustrates an alphanumerical view of a hierarchical interface 400. In an aspect, the hierarchical interface 400 may be provided in addition to or alternatively to the hierarchical interface 320. The alphanumerical view provides legal concepts arranged in a hierarchical tree structure, where a parent node 430 includes children nodes, such as node 440. In another aspect, each node may include a label 426 that may comprise a character string or other token identifying the area of law of the node, in this case “Torts.” The nodes may each include branch metadata 428 that may be provided as a character string, such as one or more legal term of art. For instance, note 430 may include the legal terms of art “dog bite,” “dog owner,” “injury liable,” and “premises.”

In embodiments, corpus data 38a may be provided to summarize one or more documents, provide document excerpts, or the like. As an example, legal decisions or statutes may be summarized in a summary 450. The summary 450 may comprise excerpts or summaries related to a search query, identified as most pertinent, or the like. The summary 450 may be expanded, hidden, removed, or the like. It is noted that the summary may provide detailed information, summaries of relevant portion, tagged passages, etc. Moreover, analytical tools may be provided similar to those described with reference to FIG. 3.

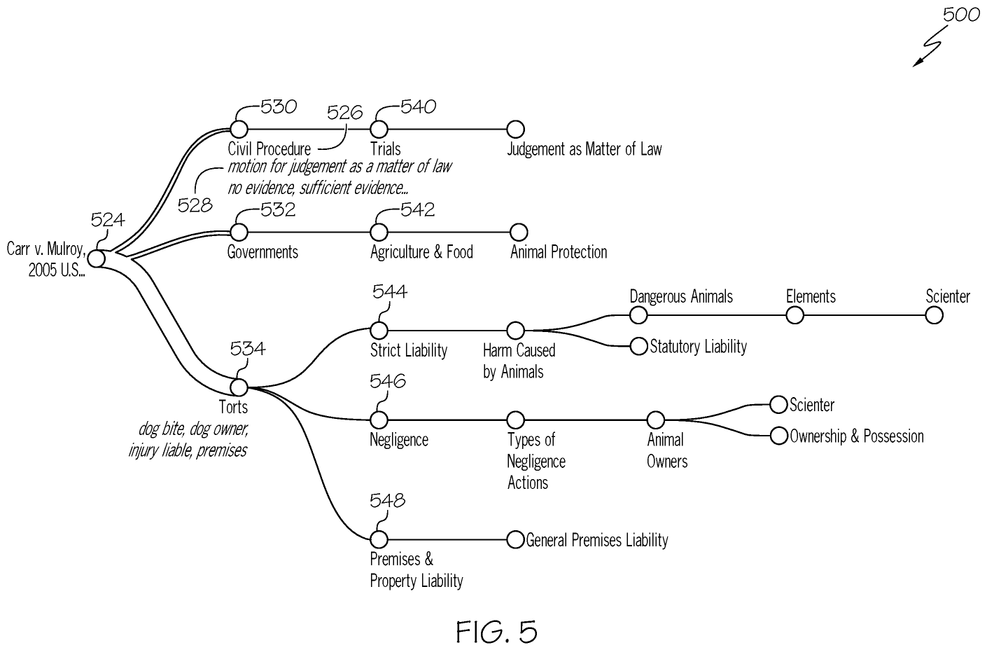

Turning to FIG. 5, there illustrated is a hierarchical interface 500 illustrating a document summary. The document summary may include a level zero node 524 identifying the document. Branching from the level zero node 524 may be one or more first level children nodes 530, 532, and 534. The first level nodes 530, 532, and 534 may include children nodes, such as second level nodes 540, 542, 544, 546, and 548. It is noted that the hierarchical interface 500 may continue with subsequent children nodes. Moreover, embodiments may include any number of nodes.

The hierarchical interface 500 generally includes legal concepts arranged in a hierarchy where parent nodes related to broader legal concepts and children nodes relate to more narrow legal concepts. Similar to hierarchical interface 320, each node may include a label 526 and branch metadata 528. The label 526 may identify an area or sub-area of law and the branch metadata 528 may identify legal terms of art. The hierarchical interface 500 may allow a user to grok the issues discussed in the document based on the legal terms of art. In another aspect, the hierarchical interface 500 may identify the degree of discussion of the legal concepts through visual indicators.

In some embodiments, the hierarchical interface 500 may additionally or alternatively be provided as a textual display similar to FIG. 4. Moreover, the hierarchical interface 500 may be compared to other hierarchical interfaces in a corpus to identify documents with similar fact patterns, discussions, or issues. It is further noted that selection of a node may bring a user to a portion(s) of the document pertinent to the node.

While described as legal concepts for a legal decision, it is noted that the hierarchical interface 500 may describe other documents or portions of a document. For instance, the hierarchical interface 500 may be provided to identify fact patterns or concept in a document (e.g., deposition transcript, court complaint, scientific or legal articles, or the like). Moreover, a user may search a corpus for documents having similar concepts, fact patterns, or the like.

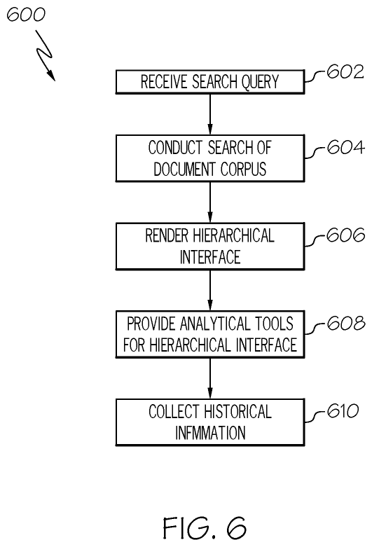

In view of the subject matter described herein, methods that may be related to various embodiments may be better appreciated with reference to the flowcharts of FIG. 6. While the methods are shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more of users, mechanical machines, automated assembly machines (e.g., including one or more processors or computing devices), or the like.

FIG. 6 depicts an exemplary flowchart of non-limiting method 600 associated with systems and methods for generating search results from a corpus and providing the search results in a graphical representation, according to various aspects of the subject disclosure. As an example, method 600 may

At 602, the method 600 may receive a search query. For instance, a user computing device 12a may provide a search query. The search query may include alphanumerical strings in structured or unstructured form. It is noted that the search query may include search parameters (e.g., jurisdiction, field or area, or the like). In some aspects, the search query may be associated with user preferences that may be utilized by various embodiments.

The method 600 may include, at 604, conducting a search of a document corpus. The search may return candidate documents from the document corpus based on a natural language comparison, metadata searches, or the like.

At 606, the method 600 may render a hierarchical interface. The hierarchical interface may represent the candidate documents identified during the search. The hierarchical interfaces may be displayed as a tree structure. In embodiments, the method 600 may display legal concepts as labels to the nodes of the tree. Additionally or alternatively, the method 600 may display branch metadata, such as legal terms of art.

At 608, the method 600 may provide analytical tools for hierarchical interface. The analytical tools may allow for analysis of search results, analysis of a search query, or the like.

At 610, method 600 may collect historic information. The historical information may include pruning information, node clicks, user initiated saves of search results or portions thereof, or the like.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

A network typically includes a plurality of elements that host logic. In packet-based wide-area networks (WAN), servers processor (e.g., devices comprising logic) may be placed at different points on the network. Servers may communicate with other devices and/or databases. In another aspect, a server may provide access to a user account. The “user account” includes attributes for a particular user and commonly include a unique identifier (ID) associated with the user. The ID may be associated with a particular mobile device and/or blender device owned by the user. The user account may also include information such as relationships with other users, application usage, location, personal settings, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, x^{th} generation partnership project long term evolution (e.g., 3G LTE, 4G LTE, 5G LTE, etc.), third generation partnership project 2, BLUETOOTH®, ultra-mobile broadband, high speed packet access, xth generation long term evolution, or another IEEE 802.XX technology. Furthermore, embodiments may utilize wired communications.

It is noted that UA's, user equipment devices, or other devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the like. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Correspondingly and notwithstanding the use of terms such as “first” or “second” in association therewith, it should be noted that the method steps, processes, and operations described herein are not to be construed as necessarily requiring their performance in the particular order discussed or illustrated, unless specifically identified as a necessary order of performance. It is also to be understood that additional or alternative steps may be employed.

Processor-implemented modules, engines, applications, systems and methods of use are disclosed herein that may provide networked access to a plurality of types of digital content, including but not limited to video, image, text, audio, data, metadata, algorithms, interactive and document content, which may track, deliver, manipulate, transform and report the accessed digital content. Described embodiments of these modules, engines, applications, systems and methods are intended to be exemplary and not limiting. As such, it is contemplated that the herein described apparatuses, systems and methods may be adapted and may be extended to provide enhancements and/or additions to the exemplary modules, engines, applications, systems and methods described, and the disclosure is thus intended to include all such extensions.

It should also be understood that the terms “platform”, “application”, “module” and “engine”, as used herein, do not limit the functionality to particular physical modules, but may include any number of tangibly-embodied software and/or hardware components having a transformative effect on at least a portion of a disclosed system and its data. In general, a computer program product in accordance with software-related embodiments may comprise a tangible computer usable medium (e.g., standard RAM, ROM, EEPROM, an optical disc, a USB drive, or the like) having computer-readable program code embodied therein, wherein the computer-readable program code is adapted to be instantiated or otherwise executed by a processor (which may work in connection with an operating system) to implement the one or more systems, functions and methods as described herein. In this regard, the disclosed software may be implemented in any desired language, and may be implemented as machine code, assembly code, byte code, interpretable source code, or the like (e.g., via C, C++, C #, Java, Actionscript, Objective-C, Javascript, CSS, XML, etc.), unless noted otherwise and by way of non-limiting example.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses:

A computer-implemented method of generating search results from a document corpus, the method comprising: providing, using a computer, document corpus wherein the document corpus comprises a plurality of documents arranged according to a structured legal taxonomy hierarchy, wherein the structured legal taxonomy hierarchy is associated with legal concepts for the plurality of documents; identifying a set of documents from the document corpus in response to receiving a search query; instructing an interface to display a hierarchical graph comprising a plurality of nodes associated with the set of documents, wherein each node includes a label identifying a legal concept associated with the node, and wherein children nodes comprise narrower legal concepts than their parent nodes.

The method for any proceeding clause, further instructing the interface to display branch metadata under at least one label for at least one node.

The method for any proceeding clause, wherein the branch metadata comprises legal terms of art associated with metadata for documents associated with the at least one node.

The method for any proceeding clause, further comprising propagating common branch metadata of sibling nodes to a parent node.

The method for any proceeding clause, further comprising generating a weight for each of the plurality of nodes according to associated legal concepts.

The method for any proceeding clause, further comprising instructing the interface to render a visual indicator of the eights of each of the plurality of nodes.

The method for any proceeding clause, further comprising receiving preferences associated with a user and instructing the interface to display the hierarchical graph based at least in part on the preferences.

The method for any proceeding clause, further comprising modifying the hierarchical graph according to user input.

The method for any proceeding clause, wherein modifying the graph comprises at least one of pruning, deleting, saving, or combining some or all of the hierarchical graph.

The method for any proceeding clause, further comprising calculating a metric associated with the hierarchical graph based on at least one of the number of first level nodes, total number of nodes, number of edges, number of paths, tree height, or number of legal concepts.

The method for any proceeding clause, further comprising comparing the metric to a threshold to determine whether to provide a suggestion for modifying the search query.

A computer-implemented system for generating search results from a document corpus, the computer-implemented system comprising a processor and a non-transitory computer-readable medium storing computer readable instructions that, when executed by the processor, cause the processor to: search the document corpus for a set of documents based on a search query, wherein the document corpus includes a plurality of documents arranged in a structured taxonomy hierarchy, wherein the taxonomy is associated with concepts; generate a hierarchical interface comprising nodes identified by concepts, wherein documents of the set off documents are linked to the nodes based on the concepts, and wherein children nodes comprise narrower concepts than their parent nodes; and instruct an interface device to display the hierarchical interface, wherein input selecting a candidate node of the hierarchical interface directs the interface device to display documents associated with the candidate node.

The system for any proceeding clause, wherein the computer readable instructions further cause the processor to instruct the interface device to display a graphical representation of the hierarchical interface.

The system for any proceeding clause, wherein the concepts comprise at least one of legal concepts, scientific concepts, or research concepts.

The system for any proceeding clause, wherein the computer readable instructions further cause the processor to filter the documents associated with the candidate node based on at least one filter criteria.

The system for any proceeding clause, wherein the at least one filter criteria comprises a practice area, date, or jurisdiction.

A computer-implemented method of generating a hierarchical summary of a document, the method comprising: providing, using a computer, a structured taxonomy hierarchy associated with a document corpus, wherein the structured taxonomy hierarchy is associated with a plurality of concepts; identifying concepts within the document based on the structured taxonomy hierarchy; generating a hierarchical structure representing the hierarchical summary of the document, wherein nodes of the hierarchical structure are associated with concepts such that parent nodes comprise concepts that encompass concepts of children nodes; and instructing an interface to display the hierarchical structure.

The method for any proceeding clause, further comprising performing a search of a document corpus for documents associated with the nodes of the hierarchical structure.

The method for any proceeding clause, wherein the concepts comprise at least one of a fact pattern, a term of art, or a legal concept.

The method for any proceeding clause, further comprising storing the hierarchical structure in a memory.

1. A computer-implemented method of generating search results from a document corpus, the method comprising:
providing, using a computer, document corpus wherein the document corpus comprises a plurality of documents arranged according to a structured legal taxonomy hierarchy, wherein the structured legal taxonomy hierarchy is associated with legal concepts for the plurality of documents;
identifying a set of documents from the document corpus in response to receiving a search query;
instructing an interface to display a hierarchical graph comprising a plurality of nodes associated with the set of documents and a plurality of edges connecting the plurality of nodes, wherein each node includes a label identifying a legal concept associated with the node, children nodes comprise narrower legal concepts than their parent nodes, the plurality of nodes are arranged in two or more levels, and the plurality of nodes and the plurality of edges illustrate a research path.

2. The computer-implemented method of claim 1, further instructing the interface to display branch metadata under at least one label for at least one node.

3. The computer-implemented method of claim 2, wherein the branch metadata comprises legal terms of art associated with metadata for documents associated with the at least one node.

4. The computer-implemented method of claim 2, further comprising propagating common branch metadata of sibling nodes to a parent node.

5. The computer-implemented method of claim 1, further comprising generating a weight for each of the plurality of nodes according to associated legal concepts.

6. The computer-implemented method of claim 5, further comprising instructing the interface to render a visual indicator of the eights of each of the plurality of nodes.

7. The computer-implemented method of claim 1, further comprising receiving preferences associated with a user and instructing the interface to display the hierarchical graph based at least in part on the preferences.

8. The computer-implemented method of claim 1, further comprising modifying the hierarchical graph according to user input.

9. The computer-implemented method of claim 8, wherein modifying the graph comprises at least one of pruning, deleting, saving, or combining some or all of the hierarchical graph.

10. The computer-implemented method of claim 1, further comprising calculating a metric associated with the hierarchical graph based on at least one of the number of first level nodes, total number of nodes, number of edges, number of paths, tree height, or number of legal concepts.

11. The computer-implemented method of claim 1, further comprising comparing the metric to a threshold to determine whether to provide a suggestion for modifying the search query.

12. A computer-implemented system for generating search results from a document corpus, the computer-implemented system comprising: a processor and a non-transitory computer-readable medium storing computer readable instructions that, when executed by the processor, cause the processor to:
search the document corpus for a set of documents based on a search query, wherein the document corpus includes a plurality of documents arranged in a structured taxonomy hierarchy, wherein the taxonomy is associated with concepts;
generate a hierarchical interface comprising nodes identified by concepts and edges connecting the nodes, wherein documents of the set of documents are linked to the nodes based on the concepts, children nodes comprise narrower concepts than their parent nodes, the nodes are arranged in two or more levels, and the nodes and the edges illustrate a research path; and
instruct an interface device to display the hierarchical interface, wherein input selecting a candidate node of the hierarchical interface directs the interface device to display documents associated with the candidate node.

13. The computer-implemented system of claim 12, wherein the computer readable instructions further cause the processor to instruct the interface device to display a graphical representation of the hierarchical interface.

14. The computer-implemented system of claim 12, wherein the concepts comprise at least one of legal concepts, scientific concepts, or research concepts.

15. The computer-implemented system of claim 12, wherein the computer readable instructions further cause the processor to filter the documents associated with the candidate node based on at least one filter criteria.

16. The computer-implemented system of claim 15, wherein the at least one filter criteria comprises a practice area, date, or jurisdiction.

17. A computer-implemented method of generating a hierarchical summary of a document, the method comprising:
providing, using a computer, a structured taxonomy hierarchy associated with a document corpus, wherein the structured taxonomy hierarchy is associated with a plurality of concepts;
identifying concepts within the document based on the structured taxonomy hierarchy;
generating a hierarchical structure representing the hierarchical summary of the document, wherein nodes of the hierarchical structure are associated with concepts such that parent nodes comprise concepts that encompass concepts of children nodes, the nodes are arranged in two or more levels, edges connect the nodes, and the nodes and the edges illustrate a research path; and
instructing an interface to display the hierarchical structure.

18. The computer-implemented method of claim 17, further comprising performing a search of a document corpus for documents associated with the nodes of the hierarchical structure.

19. The computer-implemented method of claim 17, wherein the concepts comprise at least one of a fact pattern, a term of art, or a legal concept.

20. The computer-implemented method of claim 17, further comprising storing the hierarchical structure in a memory.
